(19) United States
(12) Patent Application Publication
(10) Pub. No.: US 2026/0355919 A1
(43) Pub. Date: Nov. 12, 2026

(54) POWERED FASTENER DRIVER

(71) Applicant: TECHTRONIC CORDLESS GP, Anderson, SC (US)

(72) Inventors: Scott A. Sutherland, Greenville, SC (US); Justin Toner, Pelzer, SC (US); John R. Lyons, Piedmont, SC (US)

(21) Appl. No.: 19/669,123

(22) Filed: May 6, 2026

Related U.S. Application Data
(60) Provisional application No. 63/802,180, filed on May 8, 2025.

(51) Int. Cl. B25C 1/04; B25C 1/00; B25C 1/06

(52) U.S. Cl. CPC B25C 1/047; B25C 1/003; B25C 1/06

(57) ABSTRACT

A powered fastener driver includes a housing including a handle portion defining a first axis, a nosepiece extending from the housing, a driver blade movable within the nosepiece along a drive axis between a top-dead-center (TDC) position and a bottom-dead-center (BDC) position, a piston coupled to the driver blade for movement therewith, and a driver cylinder within which the piston is moveable and in fluid communication with a pressurized gas acting on the piston. The powered fastener driver also includes a magazine coupled to the nosepiece in which collated fasteners are receivable and defining a second axis, a lifter assembly for moving the driver blade along the drive axis from the BDC position toward the TDC position and including a first bevel gear defining a third axis, and a drive unit operably coupled to the lifter to provide torque thereto.

### CROSS-REFERENCE TO RELATED APPLICATIONS

This application claims priority to U.S. Provisional Patent Application. 63/802,180, filed on May 8, 2025, the entire contents of which are incorporated by reference herein.

### FIELD OF THE DISCLOSURE

The present disclosure relates to fastener drivers, and more particularly to mechanisms and systems for improving ergonomics of fastener drivers.

### BACKGROUND OF THE DISCLOSURE

Powered fastener drivers are used for driving fasteners (e.g., nails, tacks, staples, etc.) into a workpiece. Such fastener drivers typically include a fastener delivery system that transfers fasteners from a magazine to a driving channel, where a driver blade impacts the fastener during operation. The orientation and arrangement of components of the fastener driver play a critical role in the tool’s balance, ergonomics, and performance.

### SUMMARY OF THE DISCLOSURE

The present disclosure provides, in one aspect, a powered fastener driver including a housing including a handle portion defining a first axis, a nosepiece extending from the housing, a driver blade movable within the nosepiece along a drive axis between a top-dead-center (TDC) position and a bottom-dead-center (BDC) position, a piston coupled to the driver blade for movement therewith, a driver cylinder within which the piston is moveable and in fluid communication with a pressurized gas acting on the piston, a magazine coupled to the nosepiece in which collated fasteners are receivable, the magazine defining a second axis, a lifter assembly for moving the driver blade along the drive axis from the BDC position toward the TDC position and including a first bevel gear defining a third axis, and a drive unit operably coupled to the lifter to provide torque thereto, the drive unit including a second bevel gear defining a fourth axis that is obliquely oriented relative to the third axis by a first angle in a first plane that is perpendicular to the drive axis, and wherein the fourth axis is obliquely oriented relative to the first axis by a second angle in a second plane that is parallel to the drive axis and the first axis.

Other features and aspects of the invention will become apparent by consideration of the following detailing description and accompanying drawings.

### BRIEF DESCRIPTION OF THE DRAWINGS

FIG. 1 is a perspective view of a gas-spring powered fastener driver.

FIG. 2 is a first side plan view of the gas-spring powered fastener driver of FIG. 1 with a portion of the housing removed.

FIG. 3 is a second side plan view of a gas-spring powered fastener driver of FIG. 1 with the housing removed.

FIG. 4 is a top plan view of the gas-spring powered fastener driver of FIG. 1.

FIG. 5 is a cross-sectional view of the gas-spring powered fastener driver of FIG. 1 taken along Line 5-5 in FIG. 3 with the housing removed.

FIG. 6 is a rear plan view of the gas-spring powered fastener driver of FIG. 1, with most of the housing removed except for a handle portion.

FIG. 7 is a partial cross-sectional view of the gas-spring powered fastener driver of FIG. 1,

FIG. 8 is a cross-sectional view of the gas-spring powered fastener driver of FIG. 1 taken along Line 8-8 in FIG. 4.

FIG. 9 is an enlarged cross-sectional view of the gas-spring powered fastener driver of FIG. 1.

FIG. 10 is a perspective view of a nosepiece of the gas-spring powered fastener driver of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

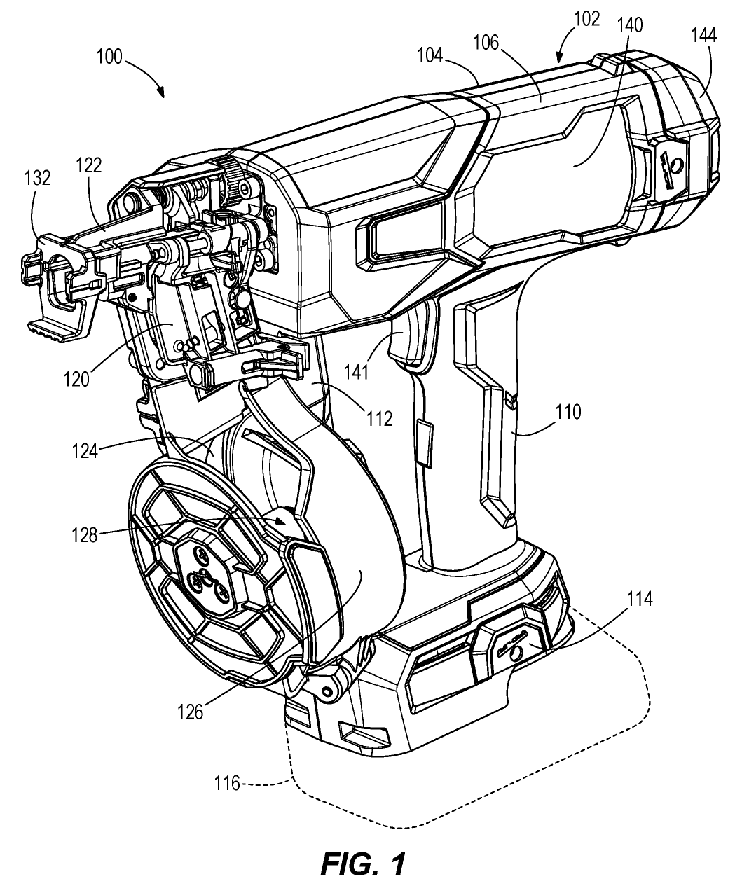

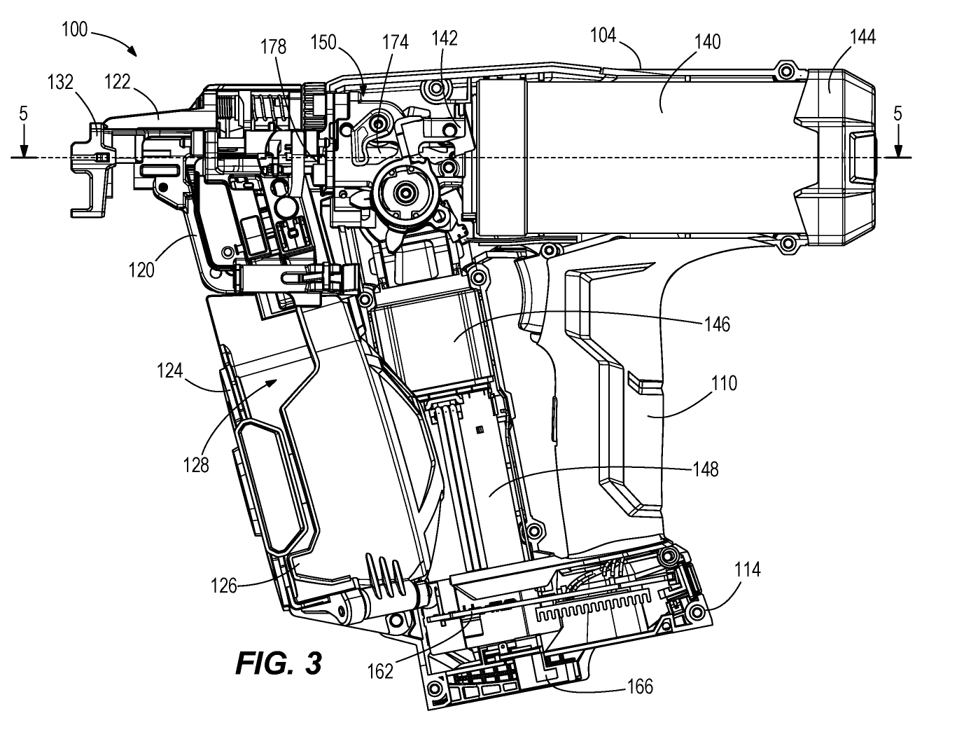

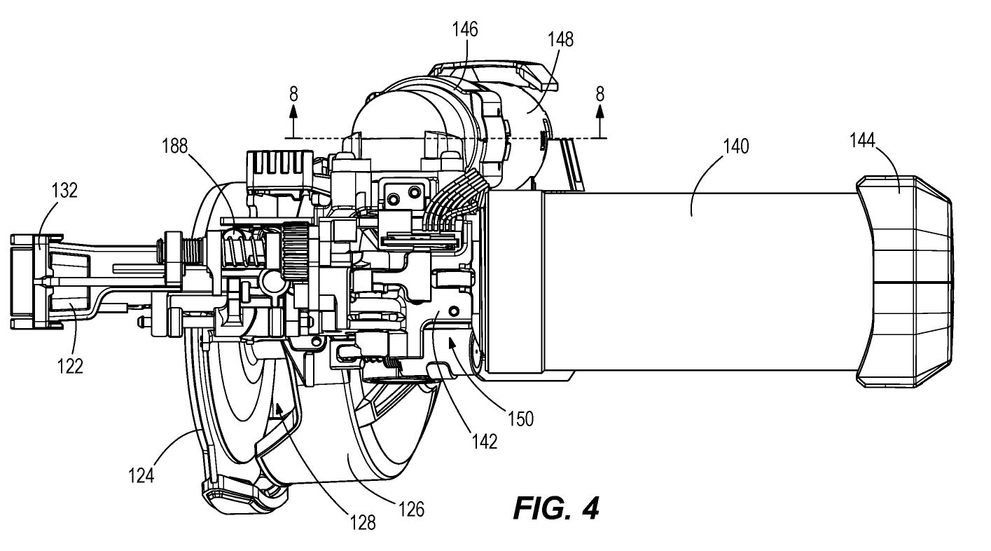

FIGS. 1-10 illustrate an embodiment of a gas spring-powered fastener driver 100. The fastener driver 100 includes a housing 102 having a first housing shell 104 joined to a second housing shell 106. The housing 102 includes a head portion 108 having a handle portion 110 and a drive unit housing portion 112 attached thereto. The housing 102 also includes a battery receptacle portion 114 that extends from the handle portion 110 that is sized and shaped to receive a removable battery pack 116 (FIG. 1).

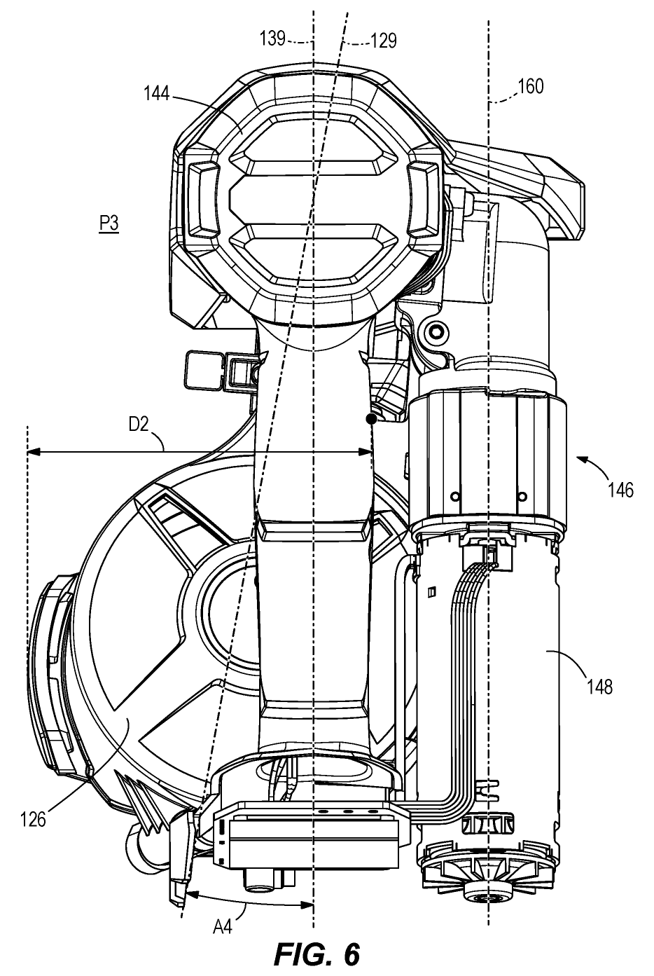

The fastener driver 100 further includes a fastener delivery portion 120 that extends along the drive unit housing portion 112 from a nosepiece 122 to a magazine 124 adjacent the drive unit housing portion 112. The magazine 124 is generally cylindrical and is sized and shaped to receive coiled fasteners therein. A magazine cover 126 is rotatably disposed on the housing 102 and provides access to a support plate 128 upon which the coiled fasteners are positioned that may be removably disposed within the magazine 124. With reference to FIG. 6, the fastener delivery portion 120 and the magazine 124 extend along a magazine axis 129. Individual fasteners are sequentially loaded from the magazine 124 to the nosepiece 122 via the fastener delivery portion 120 during operation of the fastener driver 100.

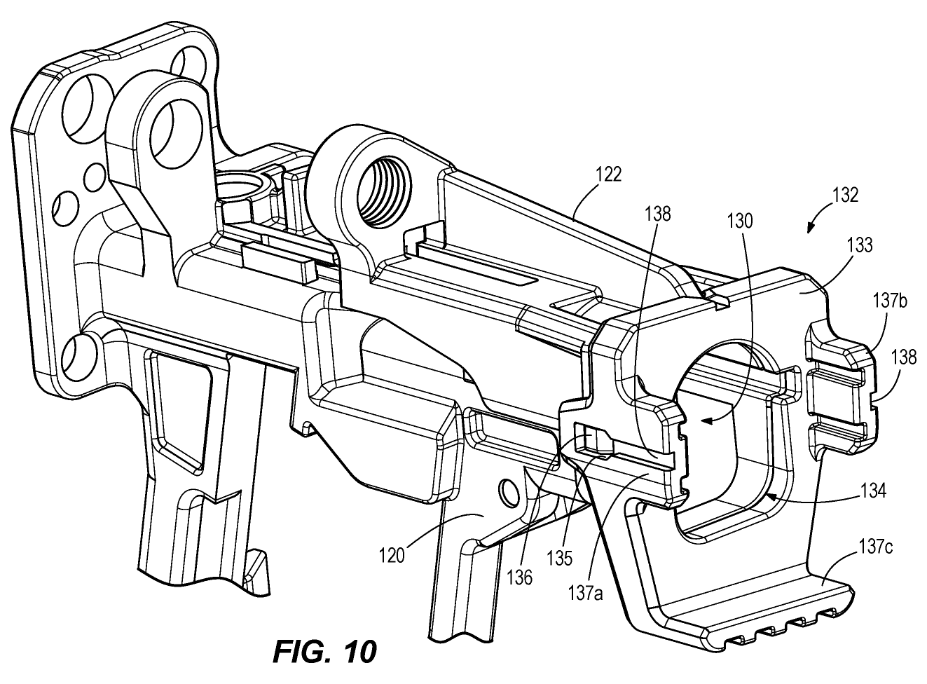

The nosepiece 122 defines a fastener driving channel 130 that guides fasteners as they are driven into a workpiece. With reference to FIG. 10, an adapter 132 is coupled to a distal end of the nosepiece 122. The adapter 132 includes a body 133 having a central bore 134 through which nails are delivered during operation. Specifically, the adapter 132 aligns the central bore 134 with the fastener driving channel 130 to guide fasteners as they are driven into a workpiece. The central bore 134 includes a shape corresponding to the fastener driving channel 130, such that the central bore 134 is aligned with the fastener driving channel 130 when the adapter 132 is coupled to the nosepiece 122. The adapter 132 further includes apertures 135 extending through opposing sides of the adapter 132. The apertures 135 are shaped and sized to receive tabs 136 protruding from opposing sides of the nosepiece 122, securing the adapter 132 to the nosepiece 122. In alternative embodiments, the nosepiece 122 may include the apertures 135 and the adapter 132 may include the tabs 136.

A first spacer 137a is positioned adjacent a first side of the central bore 134, and a second spacer 137b is positioned adjacent a second side of the central bore 134 that is opposite the first side. A third spacer 137c is positioned adjacent a third side of the central bore 134, extending along a bottom of the body 133 of the adapter 132. The spacers 137a, 137b, 137c protrude from the body 133 of the adapter 132 and provide lateral stability to prevent misalignment during operation. As shown in FIG. 10, outer surfaces of the first and second spacers 137a, 137b include one or more grooves 138 extending into the spacers 137a, 137b. The grooves 138 provide a line of sight for the user to align the tool 100 with vinyl siding.

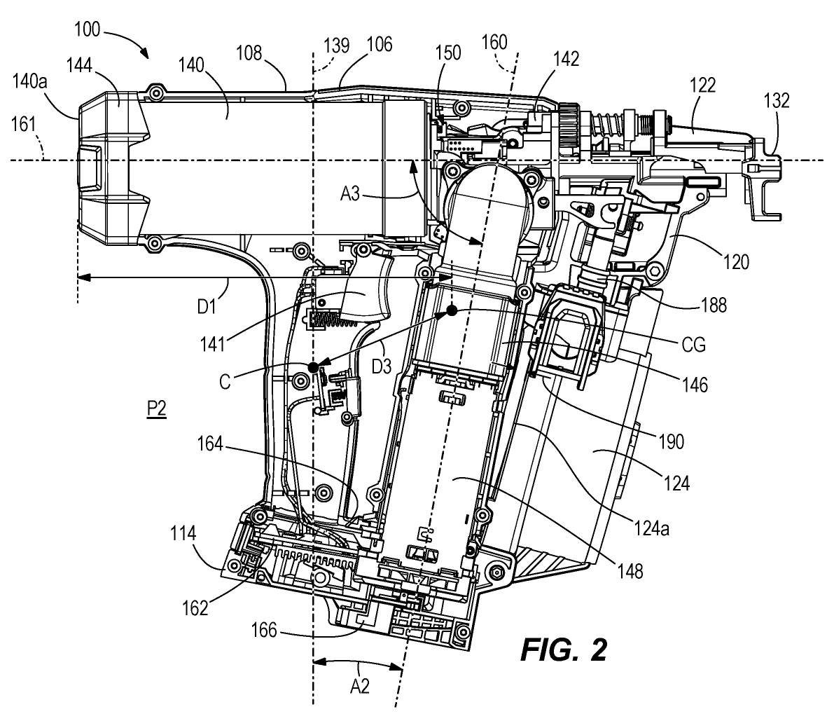

As shown in FIG. 2, the handle portion 110 defines a handle axis 139. The fastener driver 100 further includes a trigger 141 that extends outwardly from the handle portion 110 of the housing 102. In some embodiments, the housing 102 of the fastener driver 100 includes one or more vent holes formed in the first housing shell 104 and/or the second housing shell 106 to provide air flow to and from the interior of the housing 102 to help cool the internal electrical components housed therein.

As illustrated in FIGS. 2-9, the fastener driver 100 also includes several internal components. Specifically, the fastener driver 100 includes a storage chamber cylinder 140 disposed within the head portion 108 of the housing 102 and attached to a lifter housing 142. In some embodiments, the fastener driver 100 includes an air fill valve that is in fluid communication with the interior of the storage chamber cylinder 140. For example, the air fill valve may be configured as a Schrader valve, a Presta valve, a Dunlop valve, or some other similar valve. When connected with a source of compressed gas, the air fill valve enables the storage chamber cylinder 140 to be filled with compressed gas or refilled with compressed gas if any leakage occurs. In the illustrated embodiments (e.g., FIGS. 1-6), the storage chamber cylinder 140 is coupled to an end cap 144. However, in alternative embodiments, the housing 102 may including overmolding without the end cap 144.

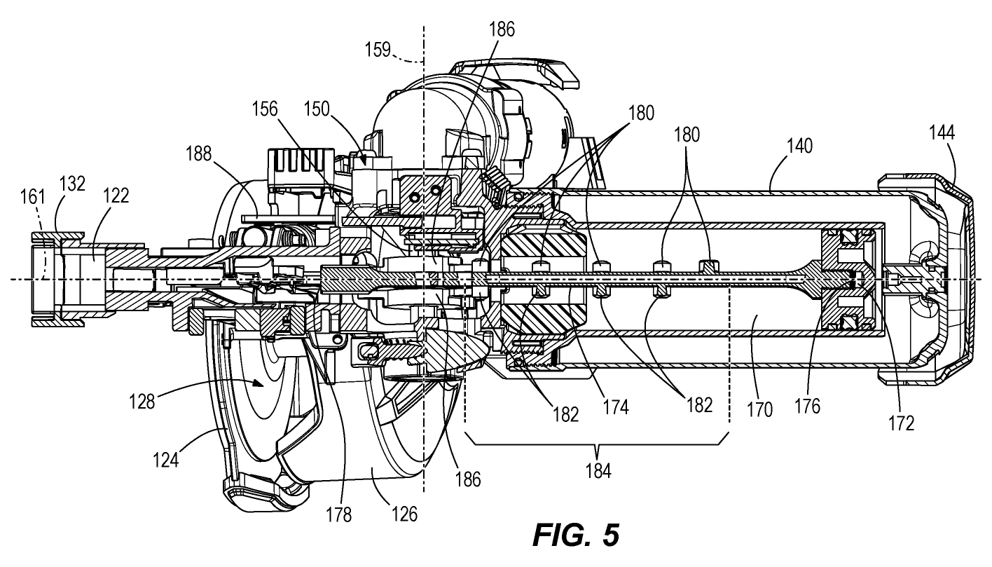

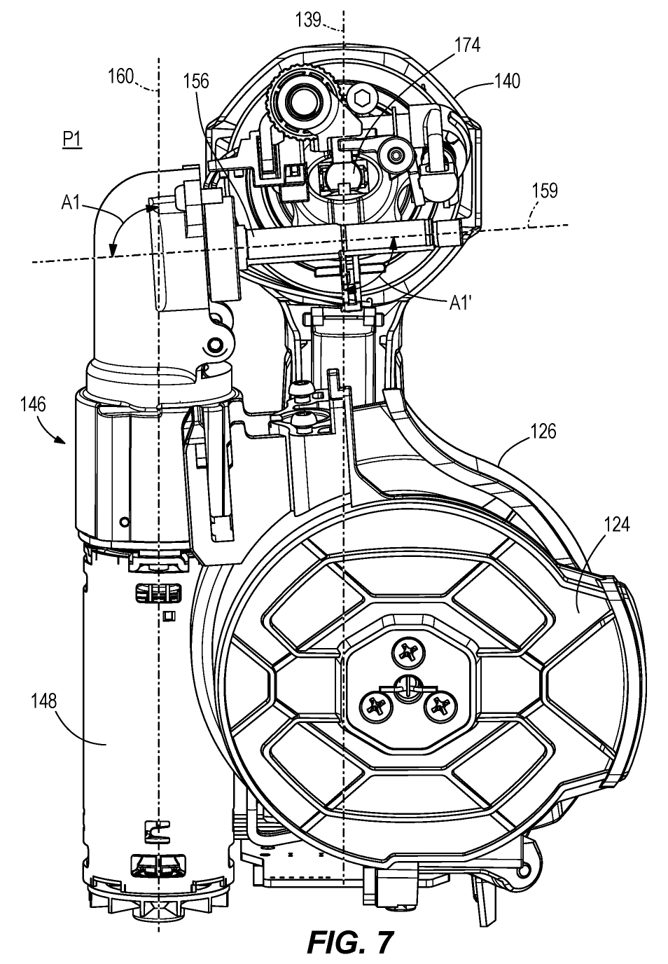

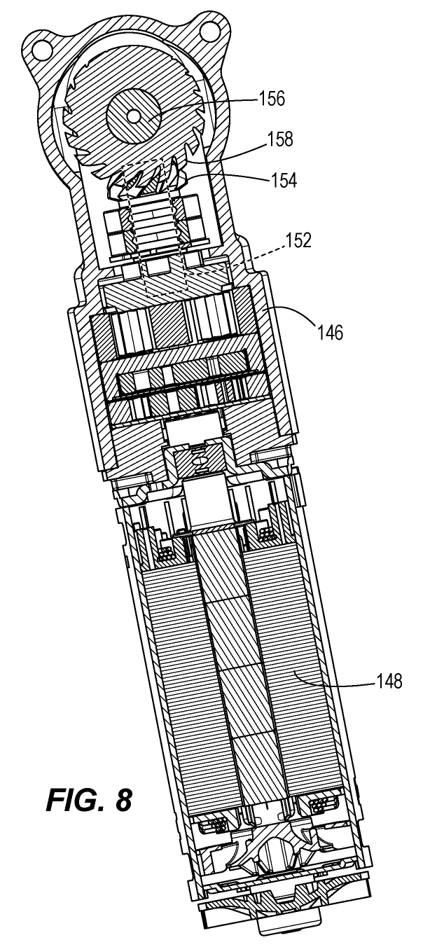

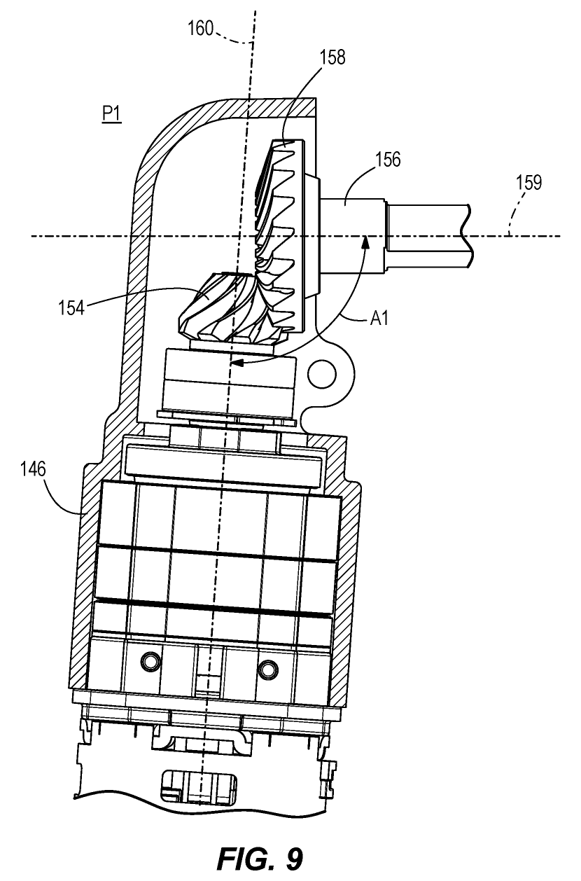

The fastener driver 100 further includes a transmission 146 coupled to the lifter housing 142. An electric motor 148 is coupled to the transmission 146. Collectively, the electric motor 148 and the transmission 146 can be considered a drive unit that supplies torque to a lifter assembly 150, which is rotatably disposed in the lifter housing 142 between the storage chamber cylinder 140 and the nosepiece 122. During operation, the motor 148 drives the transmission 146, which in turn rotates the lifter assembly 150. Specifically, with reference to FIGS. 8-9, the transmission 146 includes an output shaft 152 having a first bevel gear 154 disposed thereon, such that the first bevel gear 154 defines a first rotational axis, or a drive unit axis, 160. The lifter assembly 150 includes a drive shaft 156 (FIG. 8) having a second bevel gear 158 disposed thereon, such that the second bevel gear 158 defines a second rotational axis, or drive shaft axis, 159. As shown in FIGS. 7 and 9, the second bevel gear 158 is meshed with the first bevel gear 154 at a non-perpendicular angle. The first rotational axis 160 is obliquely oriented relative to the second rotational axis 159, such that the output shaft 152 of the transmission 146 is obliquely oriented relative to the drive shaft 156 of the lifter assembly 150 in a plane P1 that is parallel to the first rotational axis 160 and the second rotational axis 159, and perpendicular to a fastener driving axis 161. More specifically, the first rotational axis 160 is oriented by an angle A1 of approximately 94 degrees relative to the second rotational axis 159. However, A1 may be within a range of 91 degrees and 98 degrees. As best depicted in FIG. 5, the second rotational axis 159 is orthogonal to a fastener delivery axis, or drive axis, 161 of the fastener driver 100.

With reference to FIG. 6, the transmission 146 and the motor 148 extend along the drive unit axis 160. With reference to FIG. 7, due to the oblique angle A1 between the second rotational axis 159 and the drive unit axis 160, the second rotational axis 159 is also obliquely oriented relative to the handle axis 139 by an angle A1’. More specifically, because A1 and A1’ are opposite angles, the second rotational axis 159 is oriented by the angle A1’ of approximately 94 degrees relative to the handle axis 139 in the plane P1. However, similar to A1, A1’ may be within a range of 91 degrees and 98 degrees.

With reference to FIGS. 6-7, the drive unit axis 160 is oriented parallel relative to the handle axis 139, such that the transmission 146 and the motor 148 are oriented parallel relative to the handle portion 110. More specifically, the drive unit axis 160 and the handle axis 139 are oriented parallel to each other in a plane P3, that is parallel to the handle axis 139 and perpendicular to the fastener driving axis 161, and in the plane P1. This parallel arrangement occurs because the housing 102 defines the handle axis 139. As described above, the drive unit axis 160 is oriented by the angle A1 of approximately 94 degrees relative to the second rotational axis 159. The angle A1 aligns the internal components of the fastener driver 100 (e.g., the lifter assembly 150, the fastener driving channel 130, etc.) at the 94-degree angle. However, during assembly, the internal components are slightly rotated by 4 degrees to fit properly within the housing 102. This adjustment ensures that the handle axis 139, which is defined by the housing 102, remains parallel to the drive unit axis 160, which is defined by the internal components.

As shown in FIG. 2, the fastener driver 100 includes an electronic control unit 162 that controls the operation of the fastener driver 100. A user interface 164 is connected to the electronic control unit 162 and extends through the housing 102 into an area near the handle portion 110. The user interface 164 provides the user controls for the fastener driver 100 and includes, for example, an on/off switch, a mode selector button, a remaining charge indicator, a charging indicator, and other additional buttons and indicators, as necessary. The electronic control unit 162 is electrically connected to terminals 166 on the battery receptacle portion 114 which, in turn, electrically connect with the removable battery pack 116 when engaged therewith and provides DC power to the motor 148 when activated.

The storage chamber cylinder 140 includes a driver cylinder 170 disposed therein. Further, a moveable piston 172 is slidably disposed within the driver cylinder 170. A driver blade 174 is connected to the moveable piston 172 and reciprocates along the fastener delivery axis 161 between a top-dead-center (TDC) (i.e., retracted or ready) position and a bottom-dead-center (BDC) (i.e., extended or driven) position. As shown in FIG. 5, the driver blade 174 includes a proximal end 176 and a distal end 178. The proximal end 176 of the driver blade 174 is connected to the moveable piston 172 via a pin or other type of fastener. The driver blade 174 includes plurality of first posts 180 that extend from the driver blade 174 in a first direction perpendicular to the driver blade 174 and the fastener delivery axis 161 and a plurality of second posts 182 that extend from the driver blade 174 in a second direction perpendicular to the driver blade 174 and the fastener delivery axis 161 opposite the first direction. The first posts 180 and the second posts 182 may be fixed posts, in other words, they do not rotate in place. Conversely, the first posts 180 and the second posts 182 may include an outer bearing that rotates on a central post to facilitate smooth action of the driver blade 174 as it is returned to a TDC position by the lifter assembly 150.

In a particular aspect, as shown in FIG. 5, there are five pairs of opposing (and laterally aligned) first and second posts 180, 182 that are equally spaced along a lifter engagement section 184 defined along a portion of the length of the driver blade 174. It is to be understood that the driver blade 174 may include more than five pairs of first and second posts 180, 182 or fewer than five pairs of first and second posts 180, 182 depending on the stroke length of the driver blade 174, the number of teeth on one or more lifter sprockets 186 selectively engaged with the driver blade 174, or a combination thereof. As illustrated, the distal end 178 of the driver blade 174 is located adjacent the nosepiece 122 when the piston 172 is moved to a top-dead-center (TDC) (i.e., retracted or ready) position within the driver cylinder 170 and the fastener driver 100 is ready to be fired. Upon firing, the distal end 178 of the driver blade 174 is moved into the nosepiece 122 to drive a fastener from within the nosepiece 122 and into a workpiece until the piston 172 reaches a bottom-dead-center (BDC) (i.e., extended or driven) position within the driver cylinder 170.

The lifter assembly 150 selectively engages the driver blade 174 and the lifter assembly 150 is driven by the motor 148 to move the driver blade 174 from a fired position to a ready position and in the process move the piston 172 from the BDC position toward the TDC position. As the lifter assembly 150 rotates, it also engages and actuates a fastener delivery mechanism 188 for the fastener driver 100 to load fasteners into the nosepiece 122 to be driven into a workpiece. The lifter assembly 150 and the fastener delivery mechanism 188 are similar to the lifter assembly and fastener delivery mechanism disclosed in U.S. Patent Application Publication No. 2024/0149416, the entire contents of which are incorporated herein by reference. In particular, the lifter assembly 150 includes the lifter housing 142, the drive shaft 156, the lifter sprockets 186 disposed on the drive shaft 156 for moving the driver blade 174 from the BDC position toward the TDC position, and a cam rotatable in response to rotation of the drive shaft 156 for actuating the fastener delivery mechanism 188. The fastener delivery mechanism 188 is actuated by the cam to load individual fasteners into the nosepiece 122 from the magazine 124 and includes a rocker arm driven by the cam, and an advancer movable by the rocker arm.

With reference to FIG. 2, the drive unit axis 160 is obliquely oriented relative to the handle axis 139 by an angle A2. More specifically, the drive unit axis 160 is oriented by the angle A2 of approximately 11 degrees relative to the handle axis 139 in a plane P2 that is parallel to the fastener delivery axis 161 and the handle axis 139, and perpendicular to the second rotational axis 159. However, A2 may be within a range of 10 degrees and 16 degrees.

With reference to FIG. 2, the drive unit axis 160 is obliquely oriented relative to the fastener delivery axis 161 by an angle A3. More specifically, because A2 and A3 are complementary angles, the drive unit axis 160 is oriented by the angle A3 of approximately 79 degrees relative to the fastener delivery axis 161 in the plane P2. However, A3 may be within a range of 74 degrees and 80 degrees. The angles A2 and A3 position the drive unit housing portion 112 above a tapered surface 124a of the magazine 124, creating a gap 190 between the drive unit housing portion 112 and the magazine 124, as discussed in more detail below.

The angles A1 and A2 contribute to minimizing the kickout of the magazine 124. As shown in FIG. 6, the magazine axis 129 is obliquely angled relative to the handle axis 139, and the drive unit axis 160, by a kickout angle A4 in the plane P3. More specifically, the kickout angle A4 is approximately 4 degrees. However, A4 may be within a range of 1 degree and 8 degrees. By tilting the drive unit axis 160 in two dimensions (i.e., angles A1 and A2), the gap 190 is created between the drive unit housing portion 112 and the magazine 124. The gap 190 allows an internal edge of the drive unit housing portion 112 to be positioned inboard of an outer periphery of the magazine 124. The gap 190 allows the magazine 124 to be positioned closer to the handle portion 110, thus reducing the kickout angle A4.

Minimizing the kickout angle A4 has several advantages. First, it brings the magazine 124 closer to the tool’s center of gravity CG, improving overall leverage and control. Second, it enhances nail feeding by reducing sharp curves in the nail path, preventing misfeeds and ensuring smoother operation. Finally, the reduced kickout angle A4 contributes to a more compact, ergonomic design, making the fastener driver 100 easier to handle and maneuver during use.

With reference to FIGS. 2 and 6, the angles A1 and A2 also contribute to optimizing the position of a center of gravity CG of the powered fastener driver 100. By tilting the drive unit axis 160, and therefore the transmission 146 and the motor 148, by the angles A1 and A2 (e.g., outward and away from the nosepiece 122), a center of gravity CG of the fastener driver 100 is shifted closer to the handle portion 110 and closer to a center plane of the tool. Specifically, the center of gravity CG is positioned directly in front of (e.g., adjacent to) the trigger 141. More specifically, the center of gravity CG is positioned approximately 174 mm from a distal end 140a of the storage chamber cylinder 140 by a first dimension D1 (FIG. 2) in the plane P2 when the battery pack 116 is removed from the tool 100. However, the first dimension D1 may be within a range of 163 mm and 174 mm. Additionally, the center of gravity CG is positioned approximately 97 mm away from an outermost edge of the magazine by a second dimension D2 (FIG. 6) in the plane P3 when the battery pack 116 is removed from the tool 100. However, the second dimension D2 may be within a range of 94 mm and 97 mm. Further, the center of gravity CG is positioned approximately 74 mm away from a centroid C of the handle portion 110, which is defined by the position of the middle finger of a user when holding the tool 100, by a third dimension D3 (FIG. 2) when the battery pack 116 is removed from the tool 100. However, the third dimension D3 may be within a range of 57 mm and 74 mm. The positioning of the center of gravity CG slightly forward of the handle portion 110 and close to the center plane of the fastener driver 100 provides better balance and control for the user, making the fastener driver 100 feel lighter and more comfortable to maneuver.

Together, the angles A1 and A2 allow the handle portion 110, the transmission 146, and the magazine 124 to fit in a compact space improving the ergonomics by placing the center of gravity CG close to the handle portion 110. This optimized positioning enhances balance and control without negatively impacting nail loading or feeding. Therefore, angles A1 and A2 allow the magazine 124 to maintain an efficient nail feed path, ensuring smooth uncoiling and consistent operation while still achieving the desired ergonomic benefits.

Although the disclosure has been described in detail with reference to certain preferred embodiments, variations and modifications exist within the scope and spirit of one or more independent aspects of the disclosure as described.

Various features of the invention are set forth in the following claims. When used in this specification and claims, the terms "comprises" and "comprising" and variations thereof mean that the specified features, steps or integers are included. The terms are not to be interpreted to exclude the presence of other features, steps or components.

What is claimed is:

1. A powered fastener driver comprising:
a housing including a handle portion defining a first axis;
a nosepiece extending from the housing;
a driver blade movable within the nosepiece along a drive axis between a top-dead-center (TDC) position and a bottom-dead-center (BDC) position;
a piston coupled to the driver blade for movement therewith;
a driver cylinder within which the piston is moveable and in fluid communication with a pressurized gas acting on the piston;
a magazine coupled to the nosepiece in which collated fasteners are receivable, the magazine defining a second axis;
a lifter assembly for moving the driver blade along the drive axis from the BDC position toward the TDC position and including a first bevel gear defining a third axis; and
a drive unit operably coupled to the lifter to provide torque thereto, the drive unit including a second bevel gear defining a fourth axis that is obliquely oriented relative to the third axis by a first angle in a first plane that is perpendicular to the drive axis, and wherein the fourth axis is obliquely oriented relative to the first axis by a second angle in a second plane that is parallel to the drive axis and the first axis.

2. The powered fastener driver of claim 1, wherein the second angle is between 10 and 16 degrees.

3. The powered fastener driver of claim 2, wherein the second angle is approximately 11 degrees.

4. The powered fastener driver of claim 1, wherein the fourth axis is parallel relative to the first axis in the first plane.

5. The powered fastener driver of claim 1, wherein the first angle is between 91 and 98 degrees.

6. The powered fastener driver of claim 5, wherein the first angle is approximately 94 degrees.

7. The powered fastener driver of claim 1, wherein the lifter assembly includes a drive shaft defining a drive shaft axis, wherein the drive axis is orthogonally oriented relative to the drive shaft axis.

8. The powered fastener driver of claim 1, wherein a center of the gravity powered fastener driver is positioned adjacent to the handle portion.

9. The powered fastener driver of claim 8, wherein the center of gravity is positioned 174 mm from a distal end of the driver cylinder in the second plane.

10. The powered fastener driver of claim 8, wherein the center of gravity is positioned 97 mm from a distal edge of the magazine in a third plane that is perpendicular to the drive axis.

11. The powered fastener driver of claim 1, wherein the first axis is obliquely oriented relative to the second axis in a third plane that is perpendicular to the drive axis by a third angle.

12. The powered fastener driver of claim 11, wherein the third angle is between 74 and 80 degrees.

13. The powered fastener driver of claim 1, wherein an internal edge of the housing is positioned inboard of an outer periphery of the magazine.

14. The powered fastener driver of claim 13, wherein the first angle and the second angle create a gap between the drive unit portion of the housing and the magazine.

15. The powered fastener driver of claim 1, wherein the drive unit includes an output shaft obliquely oriented relative to a portion of the lifter assembly.

16. The powered fastener driver of claim 1, further comprising an adapter configured to be coupled to a distal end of the nosepiece.

17. The powered fastener driver of claim 16, wherein the adapter includes a body having a central bore through which nails are delivered, and a plurality of spacers protruding from the body.

18. The powered fastener driver of claim 17, wherein the nosepiece defines a fastener driving channel that guides fasteners, and wherein the central bore is aligned with the fastener driving channel.

19. The powered fastener driver of claim 17, wherein each of the plurality of spacers includes a groove.

20. The powered fastener driver of claim 16, wherein one of the adapter or the nosepiece includes an aperture, and the other of the adapter or the nosepiece includes a tab, and wherein the tab is configured to engage the aperture to secure the adapter to the nosepiece.
